(19) United States
(12) Patent Application Publication
(10) Pub. No.: US 2013/0060400 A1
(43) Pub. Date: Mar. 7, 2013

(54) DETECTION APPARATUS AND METHOD FOR DETECTING A CARRIER OF A TRANSCEIVER, MOTOR VEHICLE

(71) Applicant: Uwe HAHNE, Buettelborn (DE)

(72) Inventor: Uwe HAHNE, Buettelborn (DE)

(73) Assignee: GM GLOBAL TECHNOLOGY OPERATIONS LLC, Detroit, MI (US)

(21) Appl. No.: 13/598,907

(22) Filed: Aug. 30, 2012

(30) Foreign Application Priority Data
Aug. 30, 2011 (DE) 10 2011 111 899.7

(51) Int. Cl. G06F 17/00; G08G 1/16

(52) U.S. Cl. 701/1

(57) ABSTRACT

A detection apparatus is provided for detecting a carrier of a mobile transceiver relative to a vehicle, which is provided in a vehicle, that includes, but is not limited to a transmitting/receiving device, which is configured to communicate with a mobile transceiver to be detected, an environment sensor device for detecting information on the environment of the vehicle, an evaluation device, which is configured, depending on the communication and the detected information, to determine a type of carrier of the mobile transceiver and an impending collision of the carrier of the transceiver with the vehicle, and a control device, which is configured in such a manner as to control a device of the vehicle depending on the determined type of carrier in order, in the event of an impending collision of the carrier of the mobile transceiver with the vehicle determined by the evaluation device.

### CROSS-REFERENCE TO RELATED APPLICATION

This application claims priority to German Patent Application No. 10 2011 111 899.7, filed Aug. 30, 2011, which is incorporated herein by reference in its entirety.

### TECHNICAL FIELD

The technical field relates to a detection apparatus for detecting at least one carrier of a mobile transceiver relative to a vehicle, and further relates to a method for detection and a motor vehicle.

### BACKGROUND

DE 10 2009 035 072 A1 describes a method and an apparatus for predicting the position and/or the movement of an object relative to a vehicle. The method is executed with the aid of at least two apparatus units, which are disposed separately in the vehicle and on the object. The object-side apparatus part unit comprises an active or passive RFID transponder. The object-side apparatus part unit comprises a motion sensor, an acceleration sensor for measuring the translational movement of the object, a yaw rate sensor for measuring the rotary movement of the object about its vertical axis, and a magnetic compass sensor for detecting the alignment of the object to the cardinal direction. This object-side apparatus part unit can be integrated in a mobile telephone, in clothing, shoes, bags, bicycles, pet neck collars, etc. A problem with this method or this apparatus for predicting the position and/or the movement of an object relative to a vehicle however that is a road user, such as a pedestrian must necessarily be fitted with such an apparatus part unit or an RFID transponder and appurtenant movement sensors.

Against this background, it is at least one object to enable a simplified detection of road users. In addition, other objects, desirable features and characteristics will become apparent from the subsequent summary and detailed description, and the appended claims, taken in conjunction with the accompanying drawings and this background.

### SUMMARY

A detection apparatus is provided for detecting at least one carrier of a mobile transceiver relative to a vehicle, which is provided in a vehicle, comprising a transmitting/receiving device, which is configured to communicate with a mobile transceiver to be detected; comprising an environment sensor device for detecting information on the environment of the vehicle; comprising an evaluation device, which is configured, depending on the communication and the detected information, to determine a type of carrier of the mobile transceiver and an impending collision of the carrier of the transceiver with the vehicle; comprising a control device, which is configured in such a manner as to control a warning signal device and/or a vehicle device of the vehicle depending on the determined type of carrier in order, in the event of an impending collision of the carrier of the mobile transceiver with the vehicle determined by the evaluation device, to prevent this and/or reduce the accident severity of the impending collision. A motor vehicle is also provided comprising the detection apparatus.

A method is provided for detecting at least one carrier of a mobile transceiver relative to a vehicle, comprising the steps: making a communication connection with a mobile transceiver to be detected; detecting information on the environment of the vehicle; determining a carrier type of the mobile transceiver and determining an impending collision of the carrier of the transceiver with the vehicle depending on the communication with the mobile transceiver and the detected information; controlling a warning signal device and/or a vehicle device of the vehicle depending on the determined type of carrier in such a manner as, in the event of a determined impending collision of the carrier of the mobile transceiver with the vehicle, to prevent this and/or reduce the accident severity of the impending collision.

Currently, most people carry mobile transceivers such as a mobile phone. The embodiments use these mobile transceivers to detect an impending collision with the carrier of the mobile transceiver by setting up a communication with this transceiver by a detection device in a vehicle. The information thereby detected and/or data and information obtained in another way can be used to very effectively to detect the carrier, such as a pedestrian, relative to the vehicle having the detection device.

The detection apparatus detects and uses data of a carrier of a mobile transceiver such as a mobile phone in the surroundings of the vehicle in order to be able to determine the type of carrier for the. This information is further used to determine whether the carrier of the transceiver is possibly on a collision course with the vehicle even before the carrier can be detected, for example, depending on the system by an environment sensor device since the carrier, for example, is covered by another article or an object. At the same time, the detection apparatus further uses the data of the environment sensor device in order, for example, to increase the accuracy of the result of the determined type of carrier, e.g., if it is deduced from the determined data of the mobile transceiver and the environment sensor device that both have detected the same type of carrier. Depending on this, suitable countermeasures can be initiated very early on by the control device to prevent a collision.

In an embodiment, the evaluation device is further configured to determine an impending collision with the carrier of the mobile transceiver depending on a position, a motion speed and/or a direction of motion of the mobile transceiver. In another embodiment, the evaluation device is further configured to determine a carrier type of the mobile transceiver depending on a position and/or a motion speed of the mobile transceiver.

In another embodiment, the evaluation device is configured: to determine a pedestrian as a type of carrier if the detected positions of the mobile transceiver agree with information for walkways and/or the detected motion speed of the mobile transceiver lies in the range of the normal walking speed of a person, in particular in the range between approximately 0 km/h and approximately 6 km/h and/or to determine a cyclist as a type of carrier if the detected positions of the mobile transceiver agree with information for roads and cycle paths and/or the detected motion speed of the mobile transceiver lies in a range of the normal speed of a cycling person, in particular in the range between approximately 10 km/h or approximately 25 km/h and/or to determine another vehicle as the type of carrier if the detected positions of the mobile transceiver agree with information for roads and/or the detected motion speed of the mobile transceiver lies in a range of the normal speed of a motor vehicle, in particular in the range greater than approximately 25 km/h.

In an embodiment, the control device is configured, depending on the communication with the detected mobile transceiver, the determined carrier type, and/or the information detected by the environment sensor device, to control a warning signal device of the vehicle and/or a vehicle device in such a manner in order to prevent the impending collision and/or reduce the severity of the impending collision with these devices if the evaluation device has determined an impending collision of the carrier of the mobile transceiver. In another embodiment, the evaluation device is configured to determine a carrier type of the mobile transceiver depending on at least the detected positions, the detected motion speeds, and/or the detected motion profile of the mobile transceiver if no carrier type could be determined. In another embodiment, a radio interface and/or an infrared interface is provided for communication with the mobile transceiver.

In another embodiment, the detection apparatus is configured to communicate via the radio interface with a laptop, with a mobile phone, with a smart phone, with a PDA, and/or with a navigation system. In another embodiment, an environment sensor device is provided, which is part of a vehicle's internal pedestrian protection system or collision avoidance system. In another embodiment, information relating to a position, a motion speed, a motion direction, a motion profile, and/or a carrier type of the mobile transceiver are detected. In another embodiment, a standing, walking person or cycling person or another motor vehicle is provided as the carrier type of the mobile transceiver.

The above embodiments and further developments can be arbitrarily combined with one another if appropriate. Further possible embodiments, further developments and implementations of the invention also comprise combinations not explicitly mentioned of features of the invention described previously or hereinafter with reference to the exemplary embodiment. In particular, the person skilled in the art will also add individual aspects as improvements or additions to the particular basic form of the embodiments.

### BRIEF DESCRIPTION OF THE DRAWINGS

The detailed description will hereinafter be provided in conjunction with the following drawing figures, wherein like numerals denote like elements;

FIG. 1 shows a schematic view of one embodiment of a detection apparatus for detecting pedestrians and cyclists in the vehicle; and

FIG. 2 shows a sequence diagram of one embodiment of a method for detecting pedestrians and cyclists in the vehicle.

### DETAILED DESCRIPTION

The following detailed description is merely exemplary in nature and is not intended to limit application and uses. Furthermore, there is no intention to be bound by any theory presented in the preceding background or summary or the following detailed description.

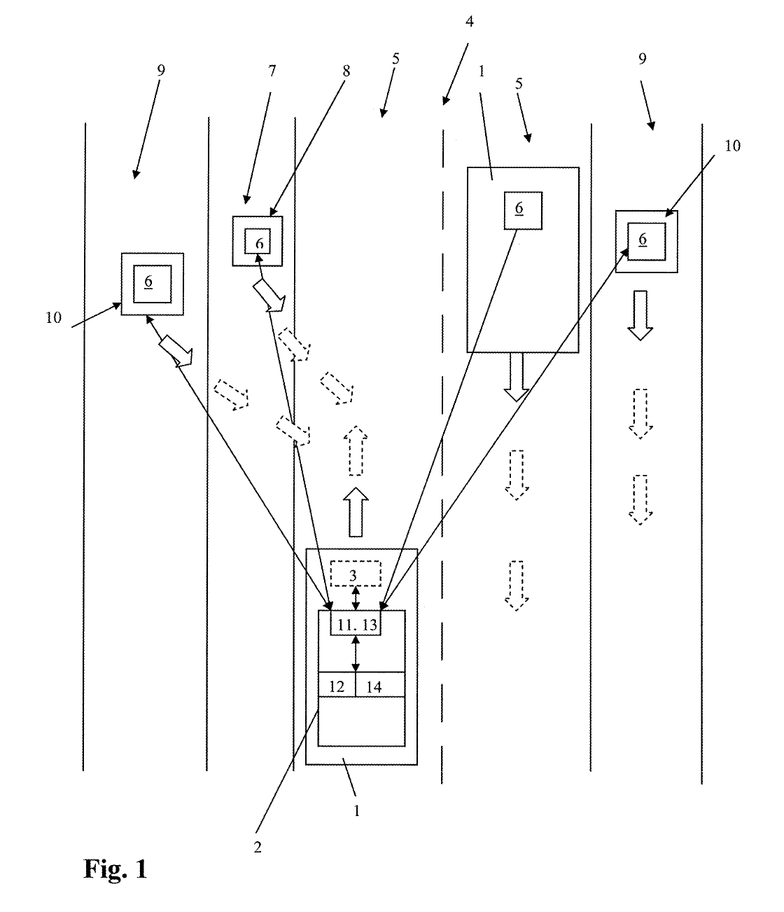

A method is provided for detecting pedestrians and cyclists in the motor vehicle with the aid of localization of mobile devices such as, for example, mobile telephones. FIG. 1 shows a schematic view of a vehicle 1 with the detection apparatus 2 for detecting unprotected persons such as, for example, pedestrians, scooter riders, motor cyclists and cyclists, who are not additionally protected by a vehicle housing. FIG. 1 shows a road 4 or carriageway with two lanes 5, where the vehicle with the detection apparatus 2 according to the invention moves on one lane 5. Furthermore, a vehicle 1 having a mobile transceiver 6, e.g. a mobile telephone, is on the move in the other lane 5. On one side of the road 4, there runs a cycle path 7 along which a cyclist 8 also with a mobile transceiver 6 such as for example a mobile telephone, is traveling. Also located on both sides of the road 4 is a walkway or sidewalk 9, on each of which a pedestrian 10 having a mobile transceiver 6 such as, for example, a mobile telephone, is on the move.

It is known that increasingly more active driving safety systems in vehicles are attempting to avoid accidents with pedestrians by active warning or active braking interventions. It is also known that attempts are being made to reduce the accident severity in the event of a collision with pedestrians with the aid of pedestrian protection systems by, for example, raising the hood or even activating airbags for the external pedestrians. Pedestrians or, however, also cyclists, are detected here with the aid of environment sensors such as, for example, cameras. However, the reliability of such systems is not yet optimal so that either pedestrians are not detected at all or are detected too late or misactivations of collision systems or pedestrian protection systems cannot be eliminated. In particular, for example, a pedestrian cannot be detected by environment sensors such as cameras if he is concealed, e.g., by another vehicle or a tree etc.

It is further known that mobile phone network operators are capable of locating mobile transceivers such as, for example mobile telephones, smart phones, Blackberrys etc. In view of the fact that today almost every mobile transceiver is GPS capable, the position of such devices can now be located even more accurately. Furthermore, present-day mobile transceivers are increasingly fitted with a radio interface e.g., WLAN and can thus communicate with other radio-capable or WLAN-capable devices. Such mobile devices comprise transmitting/receiving devices with a radio interface.

According to embodiments, now existing pedestrian protection systems or collision avoidance systems of vehicles 1 can be improved by means of the location of mobile transceivers such as, for example, mobile telephones, smart phones, BlackBerrys, laptops etc. An unprotected person such as, for example, a pedestrian or cyclist is detected in the vehicle 1 by the detection apparatus 2 where the vehicle sets up a connection to the carried mobile transceiver 6 of an unprotected person via a transmitting/detecting device 11 of the detection apparatus 2 and for an evaluation history determines at least one parameter such as its exact position, the motion speed, or the motion direction etc. To this end the detection apparatus 2 has an evaluation device 12, in which the detected data received by the transmitting/detecting device 11 are evaluated and at least one parameter such as the position, the motion speed, or the motion direction as well as the behavior or the change in position, the behavior of the motion speed, and/or the behavior of the motion direction is determined. The detected parameters form the evaluation history.

The transmitting/detecting device 11 of the detection apparatus 2 preferably has a radio interface 13 such as, for example, WLAN, BlueTooth, WiMax, GSM, GPRS, EDGE, UMTS, HSDPA, LTE, and NGMN for transmitting and receiving data of a mobile transceiver 6 such as, for example, a mobile telephone. The detection apparatus 2 preferably detects mobile transceivers 6 within a predetermined circle around the vehicle 1, where the circle can be predefined or set.

In order to determine the motion speed and the motion direction, the position of a respective mobile transceiver 6 and therefore of its carrier can be determined at least twice, for example, in a predetermined time interval. From the two positions and the time, the evaluation device 12 can then, for example, determine a motion direction vector and a motion speed of the mobile transceiver 6 and its carrier. In addition, by means of the behavior of the position, the motion speed, and the motion direction, the evaluation device 12 can determine or estimate a predicted future position or a predicted future motion behavior or path of the mobile transceiver 6 and its carrier and of the vehicle 1, as is indicated by dashed arrows in FIG. 1, and therefore a possible future collision risk of the vehicle 1 with the carrier of the mobile transceiver 6.

The detection apparatus 2 can determine the carrier type with the position of the mobile transceiver 6 detected by the transmitting/detecting device 11 of the detection apparatus 2. That is, the detection apparatus 2 determines whether the carrier of the mobile transceiver 6 is a pedestrian or cyclist as an unprotected person or another vehicle (protected object) as the carrier type. As described previously, the detection apparatus 2 can determine the behavior of the position of the mobile transceiver 6 by determining and evaluating the position of the mobile transceiver 6 several times at predetermined time intervals.

If the positions of the mobile transceiver 6 are located, for example, on the road 4, it can be assumed that the mobile transceiver 6 belongs to a vehicle 1 (type of carrier), as indicated in FIG. 1. If the positions of the mobile transceiver 6 are located most frequently on a walkway or sidewalk 9, it can be assumed that the transceiver 6 belongs to a pedestrian 10 (type of carrier), as indicated in FIG. 1. If the positions of the mobile transceiver 6 are located on a cycle path 7 and the road 4, it can be assumed that the mobile transceiver 6 belongs to a cyclist 8 (type of carrier), as indicated in FIG. 1.

In order to determine whether the mobile transceiver 6 is carried by a cyclist 8 or pedestrian 10 as type of carrier or is possibly located in another vehicle 1, the motion speed and/or the path used can also be additionally taken into account and, for example, additionally analyzed. The speed of the mobile transceiver 6 and its carrier can be determined, for example, with the time required by the mobile transceiver 6 to go from a first detected position to a second detected position.

If the mobile transceiver 6 moves for example at a speed above a predetermined threshold of, for example, approximately 10 km/h and always below a predetermined threshold of, for example, approximately 30 km/h and the mobile transceiver 6 according to its detected positions is located on roads 4 and cycle paths 7, there is a high probability that this comprises a cyclist 8 as carrier. In this case, the type of carrier is therefore a cyclist.

If on the other hand, the speed of the mobile transceiver 6 and its carrier many times or frequently has values above a predetermined threshold of, for example, approximately 30 km/h, approximately 40 km/h or approximately 50 km/h, this can most probably only comprise a vehicle 1 or motorcycle or a similar motorized vehicle. The type of carrier in this case is therefore a vehicle.

If the mobile transceiver 6 is located in the area of the road edge on a walkway or sidewalk 9 and frequently stands still and moves again at walking pace, for example at a predetermined speed between >approximately 0 km/h and ≦approximately 7 km/h, this presumably comprises a pedestrian 10. The type of carrier is therefore a pedestrian. The speed information for a cyclist, a vehicle, and a pedestrian are purely examples and the invention is not restricted to this. The speed information can be selected in any suitable manner in order to identify a specific type of carrier or in order to distinguish different types of carrier from one another, such as pedestrian, cyclist, car driver etc.

For classifying the carrier and therefore the type of carrier of the mobile transceiver 6, the mobile transceiver 6 itself informs the vehicle 1 and its detection apparatus 2 about which type of carrier this comprises. This can either be set by the carrier of the mobile transceiver 6 so that it is classified, for example, as child or adult pedestrian or the mobile transceiver 6 determines this itself by means of the motion profile of its carrier. For determining the motion profile, the mobile transceiver 6 can optionally have at least one motion sensor, acceleration sensor, yaw rate sensor, and/or magnetic compass sensor or be retrofitted with at least one of these.

The mobile transceiver 6 preferably will not begin with the determination and evaluation of such a motion profile when the vehicle 1 detects the mobile transceiver 6 but the mobile transceiver 6 creates a motion profile in advance after it is put into operation, for example, for the first time and/or every time it is switched on. In this way, immediately after it has been detected by the detection apparatus 3 in the vehicle 1, the mobile transceiver 6, such as a mobile telephone for example, can send to the detection apparatus the information that its carrier, for example, has the motion profile of a child or an adult pedestrian and the type of carrier is accordingly a child or an adult.

In one embodiment, all the data transmitted by the mobile transceiver 6 to the detection apparatus 2 of the vehicle 1 can be additionally compared with the data of conventional environment sensor-based detection apparatus 3 such as, for example, cameras, of a vehicle 1 if such a detection apparatus 3 is provided in the vehicle. As described previously, the detection apparatus 2 comprises the evaluation device 11 which compares the data detected by the mobile transceiver 6 such as the position, the motion speed and/or the path used (e.g., cycle path, walkway, or road) and optionally the type of carrier with data of an environment sensor-based detection apparatus 3 such as a camera.

If the environment sensor-based detection apparatus 3 of the vehicle 1 has, for example detected the contour of a cyclist and the detection apparatus 2 has detected a position of a mobile transceiver 6 on the cycle path 7, it can be assumed with a high probability that a cyclist 8 is actually located on the cycle path 7. By comparing the data of the environment sensor-based detection apparatus 3 and the detected data of the mobile transceiver 6, the evaluation device 12 can determine a cyclist as the type of carrier. If the data of the environment sensor-based detection apparatus 3 and the position data and motion data as well as optionally data on the type of carrier of the mobile transceiver 6 detected by the detection apparatus 2 agree, this increases the probability of existence, for example, of a pedestrian 10 as type of carrier. In this case, the driver of the vehicle 1 can be warned of a possible collision in good time, an autonomous braking intervention can be activated and/or a pedestrian protection system can be activated. To this end, the detection apparatus has a control device 14 for controlling at least one warning signal device and at least one vehicle device which are suitable for preventing an impending collision and/or for reducing the severity of the impending collision. Such a vehicle device is, for example, a braking system, an airbag system etc. If the data of the environment sensor-based detection apparatus 3 and the position data and motion data of the mobile transceiver 6 detected by the detection apparatus 2 do not agree, for example, only a warning can be output to the vehicle driver but no autonomous interventions are initiated in the vehicle 1 by the control device 14, such as for example, an autonomous braking intervention being activated.

Unprotected persons such as, for example, pedestrians and cyclists which have not yet been detected by the environment sensor-based detection apparatus 3 of the vehicle 1 but have already been detected by the location of the mobile transceiver 6 by the detection apparatus 2, can influence the warning system or systems of the vehicle 1. In this case, the control device 14 of the detection apparatus 2 can only initiate a warning to the vehicle driver such as for example a visual and/or audible signal, and optionally initiate autonomous interventions in the vehicle 1.

It is therefore possible, for example, to draw the driver's attention to a child running in the nearby area and thereby minimize the potential risk of an accident through inattentiveness. It is also feasible for the vehicle 1 to output a short warning signal if there is a potential possibility that the child could run onto the road.

It is also possible for the vehicle 1 to stop autonomously before a pedestrian crossing if a pedestrian is clearly running toward this and crossing over is extremely probable even if the environment sensors cannot yet detect the pedestrian because the pedestrian is possibly concealed. It is also possible to react to cyclists or pedestrians when turning the vehicle and to draw the driver's attention to these although these cannot be detected by lateral environment sensors such as for example cameras.

It is also part of additional embodiments that at night other unilluminated road users or pedestrians that were determined by the detection apparatus 2 can now be visualized. For example, it is possible to fade in a pedestrian symbol in a head-up display and/or to illuminate a warning that a pedestrian or cyclist is located in the danger zone. This is particularly advantageous when driving on country roads in poor visibility.

It is now possible for vehicles to communicate with unprotected persons such as for example pedestrians or cyclists, with aid of mobile transceivers without needing to contemplate new special detection equipment. By this means, active driving safety systems can be improved substantially with regard to the reaction to pedestrians or cyclists.

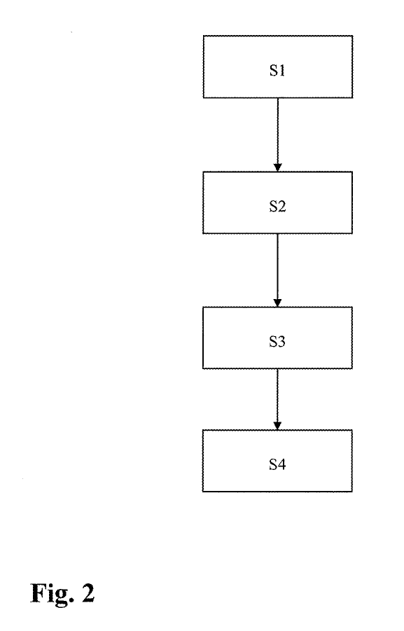

FIG. 2 shows a sequence diagram of one embodiment of a method for detecting unprotected persons such as, for example pedestrians and cyclists, in the vehicle with a detection apparatus. In a first step S1, the detection apparatus determines whether one or more mobile transceivers are located in the vicinity of the vehicle. In order to determine the vicinity in which mobile transceivers are to be detected, a predetermined circle can be predefined or set in the detection apparatus of the vehicle. If a mobile transceiver is detected, in a step S2 the detection apparatus determines one or more parameters such as the position, the motion speed, the motion direction, and/or the behavior of at least one of these parameters, for example over time. The detected parameter or parameters form an evaluation history of the detection apparatus for the mobile transceiver.

With the at least one detected parameter or the evaluation history, the type of carrier of the mobile transceiver is determined by the evaluation device of the detection apparatus as an unprotected person such as, for example, a pedestrian or cyclist, or as another motor vehicle. Furthermore, with at least one detected parameter or the evaluation history, it is determined whether a risk of collision with the detected mobile transceiver is to be expected as a result, for example, of an estimated future position or an estimated future position behavior. At the same time, an identification of the mobile transceiver can be additionally taken into account in the evaluation device.

For the evaluation history, as described previously, one or more parameters of the mobile transceiver are determined such as, for example, the position, the motion speed, the motion direction etc. In turn, the behavior or the change in the position, the behavior of the motion speed, the behavior of the motion direction etc. can be determined from this over time. By means of, for example, the position and the motion speed, the evaluation device can determine whether the type of carrier of the mobile transceiver is an unprotected person, for example, a pedestrian or a cyclist, or simply another motor vehicle.

For this purpose, the evaluation device for example compares the determined motion speeds of the detected mobile transceiver, as has been described previously with reference to FIG. 1, with a respective threshold value and/or speed range, for example, for a pedestrian, a motor vehicle, a cyclist as type of carrier etc. If the evaluation device determines that the detected speeds of the mobile transceiver are in a speed range, for example, between approximately 0 km/h and approximately 7 km/h and the threshold value of approximately 7 km/h is not exceeded, and the evaluation device additionally determines that the detected positions lie many times or most frequently on a walkway, the evaluation device determines that the carrier of the mobile transceiver is in all probability a pedestrian (type of carrier).

In a next step S3 the detection apparatus additionally compares the result of the evaluation history with information of the detected mobile transceiver and/or with the result of an environment sensor-based detection system of the vehicle which, for example comprises one or more cameras. The environment sensor-based detection system can, for example, be part of a collision avoidance system or pedestrian protection system present in the vehicle. In this way, the probability that the result of the evaluation history in step S2 is correct can be additionally increased. For this purpose, the detection apparatus asks the mobile transceiver whether the mobile transceiver has identified its carrier as a pedestrian, for example as a result of type of carrier input in the mobile transceiver, e.g., pedestrian, or as a result of a motion profile of the carrier determined by the mobile transceiver, e.g., motion profile of a pedestrian.

Mobile transceivers can be configured or retrofitted with motion sensors, acceleration sensors, yaw rate sensors and/or magnetic compass sensors etc. with which the mobile transceiver can detect the motion of the carrier. At the same time, the mobile transceiver itself can also optionally have an evaluation device in which the detected motion data are evaluated to determine the type of carrier with the detected motion profile. The mobile transceiver can also have only one storage device in which the detected motion data can be stored so that they can be retrieved. The data on the detected motion profile can then be received by the detection apparatus via its transmitting-receiving device and evaluated in the evaluation device of the detection apparatus and appropriate measures can be taken by the control device. The evaluation device of the detection apparatus can determine with the detected motion data or the detected motion profile of the mobile transceiver whether the present carrier and therefore type of carrier comprises an unprotected person, such as, for example, a pedestrian, or another motor vehicle.

Additionally or alternatively, the detection apparatus compares the result of the evaluation history with the result of an environment sensor-based detection system of the vehicle such as, for example, cameras. As described previously, the environment sensor-based detection system can for example be part of a collision avoidance system or pedestrian protection system. If the environment sensor-based detection system has also detected the contour of a pedestrian, it can be assumed with a high probability that the carrier and therefore type of carrier of the mobile transceiver is a pedestrian.

In the event that the detection apparatus comes to the same result by reference to the evaluation history and the data of the mobile transceiver and the environment sensor-based detection system, e.g., the carrier and therefore the carrier type of the mobile transceiver is a pedestrian, this can be used, in addition to a warning signal to the vehicle driver, to initiate measures to prevent a collision or reduce the severity by autonomous interventions in the vehicle, e.g., an autonomous braking intervention, by means of the control device of the detection apparatus. A prerequisite for this is that in the next step S3 it is established that the pedestrian is on a collision course with the vehicle. The control device in this case triggers at least one warning signal device and/or at least one vehicle device of the vehicle which is suitable for preventing the collision and/or for reducing the severity of the collision. Such a vehicle device is, for example, a braking system, an airbag system etc.

If the detection apparatus therefore concludes in step S2 that the type of carrier of the mobile transceiver is an unprotected person such as, for example, a pedestrian or cyclist, in a step S3 the evaluation device of the detection apparatus determines whether the unprotected person is on a collision course with the vehicle. To this end, the evaluation device can estimate with parameters such as the motion direction, the motion speed, the present position, the behavior of the motion direction, the behavior of the motion speed, and/or the behavior of the mobile transceiver and therefore of its carrier whether the mobile transceiver and its carrier are on a collision course.

If the mobile transceiver with its carrier is on a collision course with the vehicle, in a step S4 the detection apparatus can, for example, with its control device output a warning to the vehicle driver, e.g., via a visual, audible, and/or haptic signal and initiate an automatic intervention, e.g., an automatic braking intervention, airbag intervention etc., in the vehicle to prevent a collision or reduce the severity of an accident. If, on the other hand the detection apparatus establishes in step S2 that a result for the carrier of the mobile transceiver 6, e.g. the result of the evaluation history (e.g., type of carrier pedestrian) differs from the other results, e.g. the result of the data of the mobile transceiver (e.g., type of carrier cyclist) and the result of the environment sensor-based detection system (e.g., type of carrier cyclist) the detection apparatus determines that the result of the majority (here the result of the mobile transceiver and the result of the environment sensor-based detection system) is correct and the carrier and therefore type of carrier of the mobile transceiver is determined on this basis. Since both the result of the data of the mobile transceiver and also the result of the environment sensor-based detection system is a cyclist as carrier and type of carrier of the mobile transceiver, the detection apparatus therefore determines that a cyclist is assumed as the carrier of the mobile transceiver.

If it is further determined in step S3 that the cyclist as type of carrier of the mobile transceiver is on a collision course with the vehicle, the detection apparatus via its control device can, for example, only output a warning signal to the vehicle driver that a cyclist is approaching or additionally initiate measures to prevent the collision or reduce the severity of the accident such as an automatic intervention in the braking system, the steering system, the airbag system of the vehicle etc. If, on the other hand the detection apparatus establishes in step S2 that the results of the evaluation history (e.g., type of carrier pedestrian), the data of the mobile transceiver (e.g., type of carrier cyclist) and the environment sensor-based detection system (e.g., type of carrier vehicle) are all different from one another, if it is established in step S3 that the carrier of the mobile transceiver is on a collision course with the vehicle, only, for example, a warning signal is output to the vehicle driver and no additional measures are taken by the detection apparatus to avoid a collision or to reduce the severity of an accident. In this case, it cannot be unambiguously determined in step S2 what type of carrier is the carrier of the mobile transceiver. In this case, the detection apparatus does not initiate any additional measures to prevent a collision or to reduce the severity of an accident with an automatic intervention, for example, in the braking system of the vehicle etc.

If the detection apparatus determine in step S2 that the evaluation history has detected an object, e.g., a pedestrian whereas the environment sensor-based detection system has not detected an object (since it is concealed, for example) and/or the mobile transceiver sends no data to determine the carrier (object) (since, for example, it has no sensors to determine the motion profile of the carrier or a carrier type is not stored or cannot be stored), in step S4 the detection apparatus initiated a warning signal to the vehicle driver that a pedestrian is approaching and/or initiates measures to prevent a collision or to reduce the severity of an accident such as an automatic intervention in the braking system etc. A prerequisite for this is that in step S3 an impending collision with the carrier, here the pedestrian of the mobile transceiver was determined previously.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A detection apparatus for detecting a carrier of a mobile transceiver relative to a vehicle that is provided in the vehicle, comprising:
a transceiver that is configured to communicate with the mobile transceiver;
an environment sensor device that is configured to detect information on an environment of the vehicle;
an evaluation device that is configured to determine a type of carrier of the mobile transceiver and an impending collision of the carrier of the transceiver with the vehicle, depending on a communication and the information;
comprising a control device that is configured to control a device of the vehicle depending on the type of carrier in order to at least reduce an accident severity of the impending collision in event of the impending collision of the carrier of the mobile transceiver with the vehicle determined by the evaluation device.

2. The detection apparatus according to claim 1, wherein the evaluation device is further configured to determine the impending collision with the carrier of the mobile transceiver depending on a position of the mobile transceiver.

3. The detection apparatus according to claim 1, wherein the evaluation device is further configured to determine a carrier type of the mobile transceiver depending on a position of the mobile transceiver.

4. The detection apparatus according to claim 1, wherein the evaluation device is further configured to determine a pedestrian as the type of carrier if a position of the mobile transceiver agrees with information for a motion speed of the mobile transceiver that lies in a range of a normal walking speed of a person.

5. The detection apparatus according to claim 1, wherein the control device is further configured, depending on the communication with the mobile transceiver, to control the device in such a manner in order to at least reduce a severity of the impending collision with these devices if the evaluation device has determined the impending collision of the carrier of the mobile transceiver.

6. The detection apparatus according to claim 1, wherein the evaluation device is configured to determine a carrier type of the mobile transceiver depending on at least a position if the carrier type is not determined.

7. The detection apparatus according to claim 1, wherein an interface is provided for communication with the mobile transceiver.

8. The detection apparatus according to claim 1, wherein the detection apparatus is configured to communicate via a radio interface with a laptop.

9. The detection apparatus according to claim 1, wherein the environment sensor device is part of a collision avoidance system.

10. A method for detecting a carrier of a mobile transceiver relative to a vehicle, comprising:
connecting a communication connection with the mobile transceiver;
detecting information on an environment of the vehicle;
determining a carrier type of the mobile transceiver;
determining an impending collision of the carrier of the mobile transceiver with the vehicle depending on a communication with the mobile transceiver and the information;
controlling a device of the vehicle depending on the carrier type in such a manner as to at least reduce an accident severity of the impending collision.

11. The method according to claim 10, further comprising detecting information relating to a motion speed of the mobile transceiver.

12. The method according to claim 10, wherein the carrier type of the mobile transceiver is a standing person as the carrier type of the mobile transceiver.

13. The method according to claim 10, wherein the carrier type of the mobile transceiver is a walking person as the carrier type of the mobile transceiver.

14. The method according to claim 10, wherein the carrier type of the mobile transceiver is a another motor vehicle as the carrier type of the mobile transceiver.
